(19) United States
(12) Patent Application Publication
(10) Pub. No.: US 2026/0138113 A1
(43) Pub. Date: May 21, 2026

(54) PARTIAL OXYGENATION REACTOR

(71) Applicant: GasTechno Corp, Boyne Falls, MI (US)

(72) Inventors: Walter BREIDENSTEIN, Boyne Falls, MI (US); James W. PROSCIA, Las Vegas, NV (US)

(73) Assignee: GasTechno Corp, Boyne Falls, MI (US)

(21) Appl. No.: 19/390,918

(22) Filed: Nov. 17, 2025

Related U.S. Application Data
(60) Provisional application No. 63/721,658, filed on Nov. 18, 2024.

(51) Int. Cl. B01J 19/08; B01F 23/10; B01F 23/70; B01F 25/431; B01F 25/434; B01F 35/221; B01F 101/00; B01J 4/00; B01J 19/00

(52) U.S. Cl. CPC B01J 19/088; B01F 23/10; B01F 23/711; B01F 25/4312; B01F 25/43172; B01F 25/431971; B01F 25/434; B01F 35/2211; B01J 4/008; B01J 19/0013; B01F 2101/2204; B01J 2204/002; B01J 2204/007; B01J 2219/00123; B01J 2219/002; B01J 2219/00213; B01J 2219/00234; B01J 2219/0801; B01J 2219/0845; B01J 2219/0871; B01J 2219/0883; B01J 2219/182

(57) ABSTRACT

An apparatus for partial oxidation hydrocarbons includes a mixing chamber configured to receive a first gas feed stream and a second gas feed stream. One of the first gas feed stream and the second gas feed stream includes a hydrocarbon-containing gas while the other includes an oxygen-containing gas. The mixing chamber includes an outer tube section having a first input port configured to receive the first gas feed stream and an internal flow diverter mounted internally to the outer tube section. The internal flow diverter includes a second input port that receives the second feed gas stream and a flow diverter wall that defines a central flow channel configured for the second gas feed stream to flow therethrough. A tubular flow reactor is configured to support the partial oxidation of the hydrocarbon-containing gas as it flows axially therethrough.

### CROSS-REFERENCE TO RELATED APPLICATIONS

This application claims the benefit of U.S. provisional application Ser. No. 63/721,658 filed Nov. 18, 2024, the disclosure of which is hereby incorporated in its entirety by reference herein.

### TECHNICAL FIELD

In at least one aspect, the present invention is related to methods and systems for partially oxidized hydrogens, and in particular, methane.

### SUMMARY

In at least one aspect, an apparatus for partial oxidation hydrocarbons is provided. The apparatus includes a mixing chamber configured to receive a first gas feed stream and a second gas feed stream. One of the first gas feed stream and the second gas feed stream includes a hydrocarbon-containing gas while the other includes an oxygen-containing gas. The mixing chamber includes an outer tube section having a first input port configured to receive the first gas feed stream and an internal flow diverter mounted internally to the outer tube section. The internal flow diverter includes a second input port that receives the second feed gas stream and a flow diverter wall that defines a central flow channel configured for the second gas feed stream to flow therethrough. The flow diverter wall defines a plurality of gas dispersing channels configured to permit the second gas feed stream to flow out of the internal flow diverter and into a mixing zone defined by the outer tube section and the flow diverter wall. The plurality of gas dispersing channels includes subsets of gas dispersing channels oriented with at least two different angles with respect to the flow diverter wall to promote the mixing of the first gas feed stream and of the second gas feed stream to form a reactive mixture. A tubular flow reactor is in fluid communication with the mixing chamber and configured to receive the reactive mixture. The tubular flow reactor is configured to support the partial oxidation of the hydrocarbon-containing gas as it flows axially therethrough. A controller is configured to regulate flow of the first gas feed stream and the second gas feed stream.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a further understanding of the nature, objects, and advantages of the present disclosure, reference should be had to the following detailed description, read in conjunction with the following drawings, wherein like reference numerals denote like elements and wherein:

FIG. 1. Schematic of a partial oxidation apparatus.

FIG. 2A. Longitudinal cross-section of a mixing chamber used in the apparatus of FIG. 1.

FIG. 2B. Transverse cross-section of a mixing chamber used in the apparatus of FIG. 1.

FIG. 2C. Internal view of a mixing chamber used in the apparatus of FIG. 1.

FIG. 3A. Perspective view of an internal flow diverter that is inserted io the mixing chamber.

FIG. 3B. Cross section of a portion of an internal flow diverter wall.

FIG. 3C. Cross section of a portion of an internal flow diverter wall.

FIG. 4. Schematic of a partial oxidation system that incorporates the apparatus of FIG. 1.

FIG. 5. Schematic of a partial oxidation system that incorporates the apparatus of FIG. 1.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred.

The term “alkyl” refers to C₁₋₂₀ inclusive, linear (i.e., “straight-chain”), branched, saturated or at least partially and in some cases fully unsaturated (i.e., alkenyl and alkynyl) hydrocarbon chains, including for example, methyl, ethyl, propyl, isopropyl, butyl, isobutyl, tert-butyl, pentyl, hexyl, octyl, ethenyl, propenyl, butenyl, pentenyl, hexenyl, octenyl, butadienyl, propynyl, butynyl, pentynyl, hexynyl, heptynyl, and allenyl groups. “Branched” refers to an alkyl group in which a lower alkyl group, such as methyl, ethyl or propyl, is attached to a linear alkyl chain. “Lower alkyl” refers to an alkyl group having 1 to about 8 carbon atoms (i.e., a C₁₋₈ alkyl), e.g., 1, 2, 3, 4, 5, 6, 7, or 8 carbon atoms. “Higher alkyl” refers to an alkyl group having about 10 to about 20 carbon atoms, e.g., 10, 11, 12, 13, 14, 15, 16, 17, 18, 19, or 20 carbon atoms.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

The phrase “composed of” means “including,” “comprising,” or “having.” Typically, this phrase is used to denote that an object is formed from a material.

The term “axial flow” means the average flow direction of gases in a tubular reactor parallel to the longitudinal axis.

The term “fluid communication” means there is a pathway or connection between components through which a fluid can flow or be transferred.

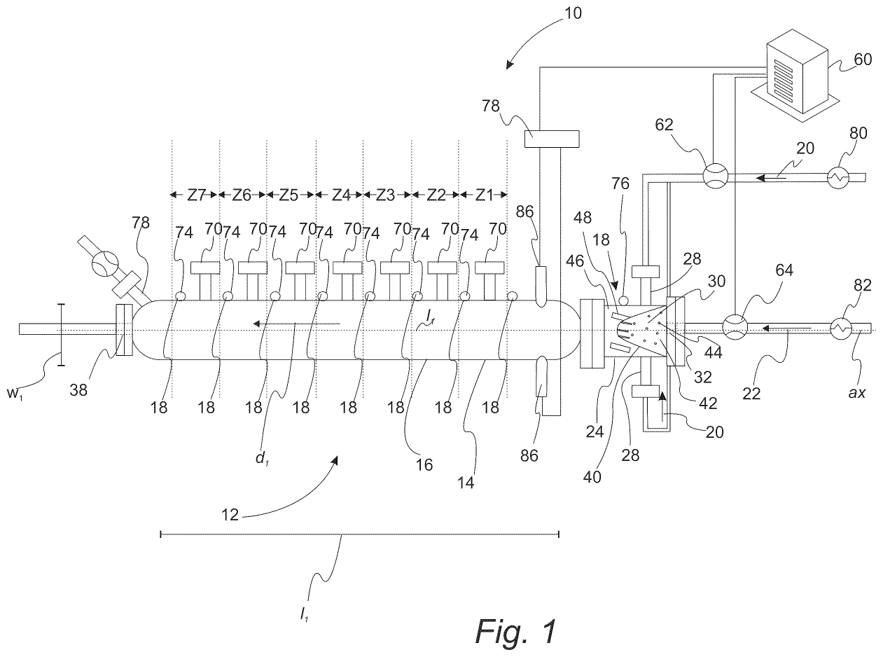

FIG. 1 provides a schematic of an apparatus for the partial oxidization of a hydrocarbon-containing gas. The apparatus facilitates the direct partial oxidization conversion of at least one C₁-C₄ alkane into as least one alkyl oxygenate. In particular, the direct partial oxygenation conversion of methane into methanol is a focal conversion goal of the technology. Partial oxidation apparatus 10 includes tubular flow reactor 12 that is configured to support the partial oxidation of an alkane-containing gas as it flows axially therethrough. Tubular flow reactor 12 includes reactor tube 14 which is hollow and tube-shaped. Reactor tube 14 is defined by a length l₁ and a width w₁ with a longitudinal axis a₁ along the length of the reactor tube. Gases flow through reactor tube 14 is axial flow on average along direction d₁.

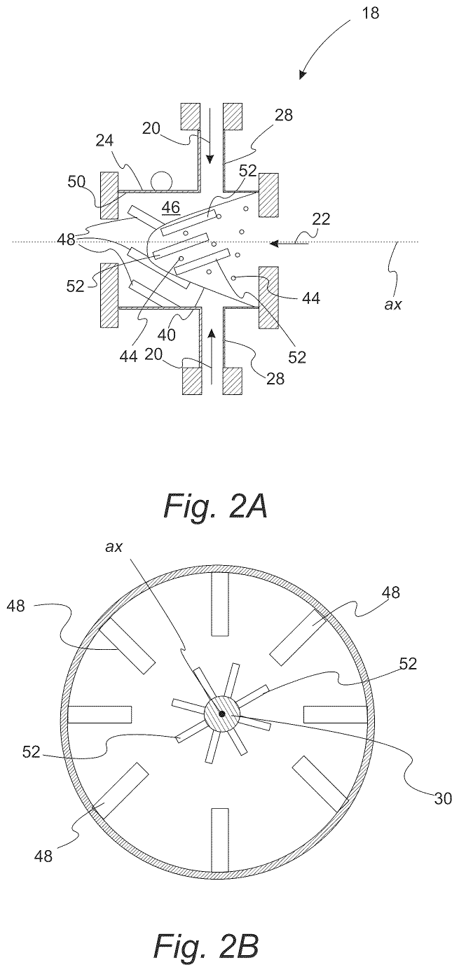

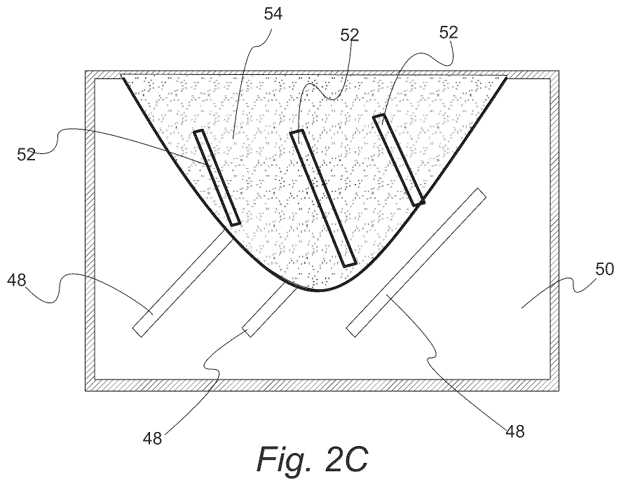

Referring to FIGS. 1 and 2A-2C, partial oxidation apparatus 10 includes a mixing chamber 18 configured to receive a first gas feed stream 20 and a second gas feed stream 22. FIG. 2A is a cross-section of the mixing chamber. Characteristically one of the first gas feed stream 20 and a second gas feed stream 22 includes a hydrocarbon-containing gas while the other includes an oxygen-containing gas. In a refinement, the oxygen-containing gas has greater than 80 wt % oxygen content to reduce the accumulation of inert gases by the recycling process. In a refinement, the first gas feed stream 22 includes hydrocarbon-containing gas and the second feed stream 22 includes an oxygen-containing gas. In another refinement, the first gas feed stream 22 includes an oxygen-containing gas and the second feed stream 22 includes a hydrocarbon-containing gas. In a refinement, compressed air with pressure, for example, of 7-8 MPa and with an oxygen content of about 80 vol. % to 100 vol. % and, preferably, 90 vol. % to 95 vol. % oxygen is supplied from a compressor. In another refinement, the oxygen-containing gas is obtained from substantially pure oxygen gas. Advantageously, between 2 vol % and 3 vol % O₂ of the total volume of the reactants are reacted with the heated hydrocarbon-containing gas.

Referring to FIGS. 1, 2A-D, and 3A-C, mixing chamber 18 includes an outer tube section 24 having one or more input ports 28 configured to receive the first gas stream 20. Internal flow diverter 30 is mounted internally to the outer tube section 24. Internal flow diverter 30 includes a second input port 32 that receives the second gas stream 22. Internal flow diverter 30 includes a flow diverter wall 40 that defines a central flow channel 42 configured for the second gas feed stream to flow therethrough, the flow diverter wall defining a plurality of gas dispersing channels 44 configured to permit the second gas feed stream to flow out of the internal flow diverter 30 and into a mixing zone 46 defined by the outer tubes section 24 and the flow diverter wall 40. In a refinement, the plurality of gas dispersing channels 44 includes subsets of gas dispersing channels oriented with at least two different angles with respect to the flow diverter wall to promote mixing of the first gas feed stream and of the second gas feed stream to form a reactive mixture that flows to the tubular flow reactor. In a refinement, the plurality of gas dispersing channels 44 are arranged in a pattern that spirals around the mixing chamber. In another refinement, the plurality of gas-dispersing channels is arranged such that adjacent channels are oriented in different directions.

Referring to FIGS. 1 and 2A-C, a plurality of fins can be mounted on an internal surface of the mixing chamber, each fin angled to promote gas mixing. For example, fins 48 are mounted on an internal surface of outer tubes section 24. Typically, fins 48 protrude into mixing zone 46 and are angled with respect to the longitudinal axis ax. Similarly, a plurality of fins 52 are mounted on an external surface 54 of flow diverter wall 40. These fins 52 protrude into the mixing zone 46 and are angled with respect to the longitudinal axis ax.. In a refinement, fins 48 are angled with respect to the longitudinal axis ax at different angles than fins 52.

Referring to FIG. 1, tubular flow reactor 12 is in fluid communication with the reactor mixing chamber 18. Advantageously, the tubular flow reactor 12 is configured to support the partial oxidation of the hydrocarbon-containing gas as it flows axially therethrough. The reacted gas exits the tubular flow reactor 12 through exit port 54. Controller 60 is configured to regulate the flow of the first gas feed stream and the second gas feed stream. In this regard, the controller can be in electrical communication with flow controllers 62, 64. In a refinement, controller 60 is a microprocessor-based controller. Examples of software packages that controller 60 can implement for controlling the components of partial oxidation apparatus 10 and any systems incorporating the apparatus include SCADA® software, LABVIEW®, LABWINDOWS®, and the like.

Referring to FIG. 1, a plurality of reaction zones Zn can be defined in the tubular flow reactor where n is an integer label for each zone. Typically, each reaction zone has a quench input configured to allow flow of a quench gas therethrough to cool the tubular flow reactor. In this regard, tubular flow reactor 12 can include a plurality of quench inlet ports 70. In a refinement, each reaction zone Zn can have a quench inlet 70 configured to allow a flow of a quench gas therethrough to cool the tubular flow reactor. In a further refinement, a temperature measuring unit 74 associated with each zone is configured to measure the temperature of the associated reaction zone. In a refinement, a temperature measuring unit 76 measures the temperature of the mixing chamber 18. In a refinement, tubular flow reactor 12 can also include an exhaust outlet port 78 for venting gas from the tubular flow reactor.

Controller 60 is configured to provide send a signal to a flow controller or flow switch to provide a quench gas to one or more quench inputs if the temperature of any reaction zone has a value greater than a predetermined temperature.

Referring to FIG. 1, partial oxidation apparatus 10 includes a first heater 80 for heating the first gas feed stream and a second heater 82 for heating the second gas feed stream. In a refinement, the first heater and the second heater are configured to heat the first gas feed stream and the second gas feed stream, respectively, to a sufficient temperature (e.g., from 430 to 470° C.) to form alkyl free radicals in the mixing chamber. In a further refinement, at least a portion of the alkyl free radicals flow into the tubular flow reactor.

Referring to FIG. 1, an igniter 86 can be mounted in the tubular flow reactor, the igniter configured to generate alkyl free radicals in a sufficient concentration to initial partial oxidation of the hydrocarbon-containing gas as it flows therein. Controller 60 can be configured to operate the igniter 86. In a refinement, igniter 86 is a hot surface igniter. In another refinement, igniter 86 is one or more spark igniters. Typically, an ignition control module 88 can be used for controlling the spark igniters. In a refinement, controller 60 is configured to send control signals to the ignition control module 88 and thereby control sparking of the one or more spark igniters. In particular, controller 60 is configured to send control signals to the ignition control module to set the timing of sparks from the spark igniter. In one refinement, sparks can be sent continuously during operation.

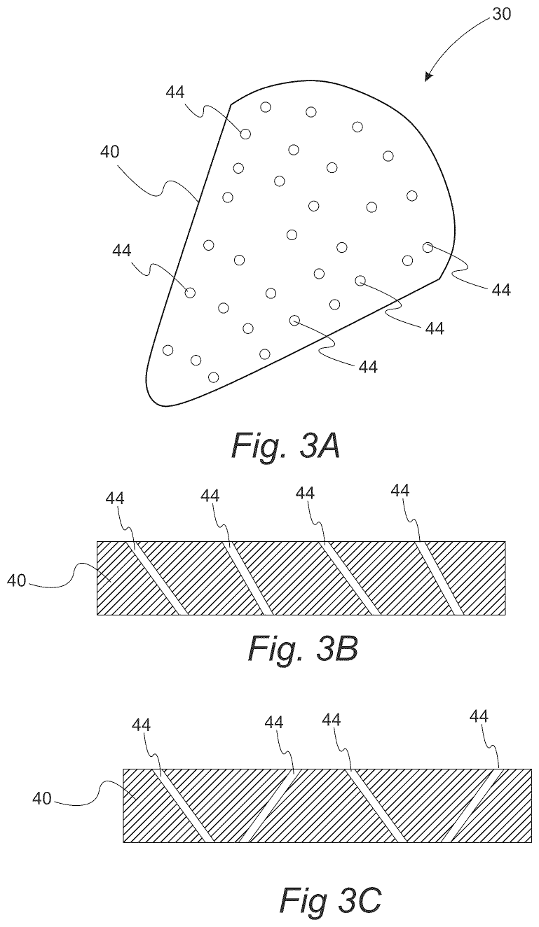

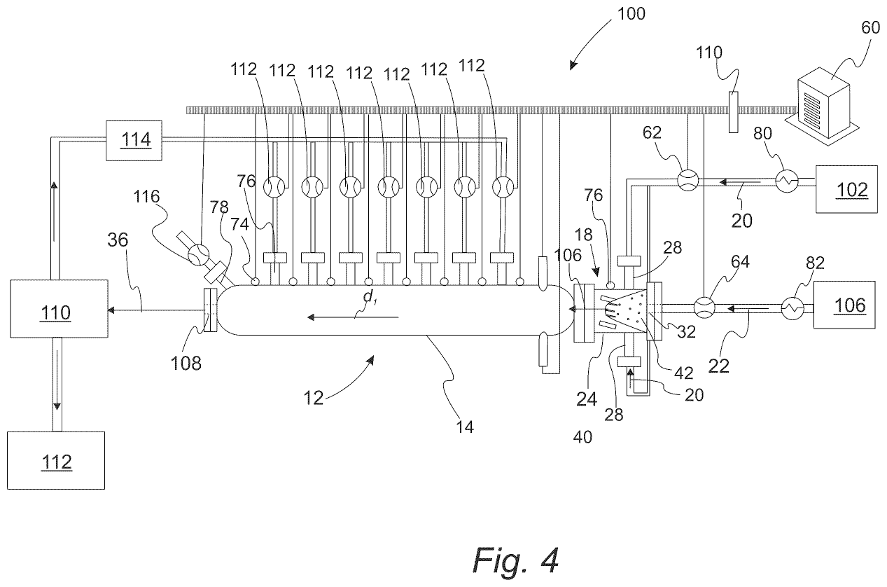

FIG. 4 provides a schematic of a system for partial oxidation including the apparatus of FIGS. 1 to 3. Partial oxidation system 100 includes mixing chamber 18 in fluid communication with reactor tube 14. Typical, mixing chamber 18 is attached to reactor tube 14 with flange connectors. Without loss of generality, a hydrocarbon source 102 provides the first gas feed stream 20 to mixing chamber 18 through input port 28. Heater 80 can be used to preheat the first gas stream. Flow control or valve 62 can be used to allow the flow of the first gas stream to mixing chamber 18 as described above. Similarly, an oxygen source 104 provides the second gas feed stream to mixing chamber 18. Heater 82 can be used to preheat the first gas stream.

In a refinement, compressed air with pressure, for example, of 7-8 MPa and with an oxygen content of about 80 vol. % to 100 vol. % and, preferably, 90 vol. % to 95 vol. % oxygen is supplied from a compressor. In another refinement, the oxygen-containing gas is obtained from substantially pure oxygen gas. Advantageously, between 2 vol % and 3 vol % O₂ of the total volume of the reactants are reacted with the heated hydrocarbon-containing gas.

Flow control or valve 64 can be used to allow the flow of the second gas stream 22 to mixing chamber 18 through the second input port 32 as described above. It should be appreciated that in an alternative variation, the second gas feed stream can be flowed into input port 28 and the first gas feed stream can be flowed into the second input port 32. After the first and second gas stream mix in mixing chamber 18 the reactive mixture 106 flows into reactor tube 14 where the partial oxidation of the hydrocarbon gas proceeds. The reacted gas exits through exit port 38 which is in fluid communication with purification system 110. The reacted gas enters purification system 110 which separates partial oxygenated products from the reacted gas which are collected in collection stations 112. In a refinement, the reacted gas is initially cooled (e.g., with a heat exchanger) after entering purification system 110.

In a refinement, unreacted hydrocarbon-containing gas 114 is recycled. In one refinement, the unreacted hydrocarbon-containing gas 114 is cooled at cooling station 116 and then used as the quench gas described above. In another refinement, the unreacted hydrocarbon-containing gas 114 can be combined with the input gas stream to mixing chamber 18.

Controller 60 is used to control a number of components for system 100 or acquire data therefrom, typically via interface 110. As set forth above, controller 60 controls flow controllers and/or valve 62, 64 to control the flow of the first and second gas feed streams. Controller 60 can also be used to control to operate valve 116 which allows gases to vent from reactor tube 14. when necessary.

For example, control 70 can be configured to obtain temperature readings from temperature-measuring units 74 and 76. In a refinement, control 70 controls flow controllers or valve 112 which regulates flow of the quench gas into reactor tube 14. When a temperature in one or more zones is higher than a predetermined valve, control 60 can be configured to active flow through one or more quench ports 76.

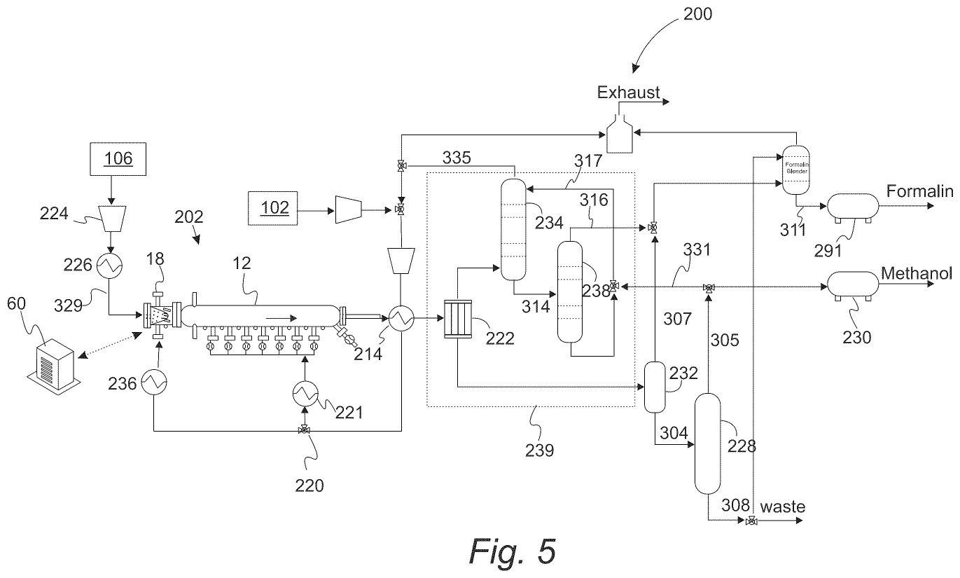

FIG. 5 provides a schematic of a system for partial oxidation including the apparatus of FIGS. 1 to 3. Partial oxidation system 200 includes the partial oxidation apparatus 10 described above. In particular, two-stage reactor 202 includes and mixing chamber 18 in fluid communication with the tubular flow reactor 12. Two-stage reactor 202 facilitates a gas phase oxidation of a hydrocarbon-containing gas. A heated hydrocarbon-containing gas stream (from valve 220 and heater 236) and an oxygen-containing gas from line 29 are introduced into two-stage reactor 202. The oxygen-containing gas preferably has greater than 80% oxygen content to reduce the accumulation of inert gases by the recycling process. The two-stage reactor 202 further optionally receives a quenching cold hydrocarbon-containing gas stream from valve 220 and heat exchanger 221 for reducing the temperature of the reaction during the operation of the apparatus.

The partial oxidation system can also include device 214 for cooling the reaction product stream mixture before separation. Additionally, partial condenser 222 incorporates a gas-liquid heat exchanger to further reduce the temperature of the products. The condenser 222 separates H₂O and alcohols from a hydrocarbon-CO₂ mixture. The partial condenser 222 is preferably isobaric, as opposed to isothermal, to avoid pressure losses. The reaction product stream enters, and a liquid stream and gaseous stream exit condenser 222.

Block 239 represents equipment that is configured to separate contaminants and products from a hydrocarbon-containing recycle gas component. In this regard, equipment 239 is configured to remove CO₂ from the reduced product stream. Equipment 239 can take the form of a purge valve, absorber, membrane separator, or adsorber. It is envisioned that equipment 239 can be used to regulate the percentage of other non-reactive components such as N₂ with, for example, a purge valve.

In the event the system is configured to recover formaldehyde, the gaseous reduced product stream leaves the isobaric condenser 222 and is passed to the scrubber 234. Other potential methods that can be utilized use materials such as various amines known to remove CO₂ and formaldehyde.

To fulfill the minimum absorption requirements, modification of the flow rate of methanol or operating temperature of the scrubber column can be used. If it is desirable to operate at extremely low absorbent flow rates, then a lower temperature can be utilized, for example 0° C. If it is desirable to operate at ambient temperatures or temperatures achievable via cooling water, then a high flow rate can be utilized, for example, ten times that of the flow rate for 0° C. In either scenario, the pregnant methanol absorbent stream 314 is completely regenerated by the formaldehyde distillation column 238. Optionally, the stream 314 from the scrubber 234 can be passed through the condenser 222 to provide cooling of the product stream and preheating of the methanol recycle to improve the energy efficiency of the formaldehyde distillation column 238.

Two stage reactor 202 is connected with a compressor 224 and heater 226 for supply of compressed and heated oxygen-containing gas. The raw hydrocarbon-containing gas is mixed with cleaned hydrocarbon gas from the scrubber 234 and is heated using a heater 236. In the event the raw hydrocarbons have a high CO₂ content, the raw hydrocarbons can be mixed with the reduced product hydrocarbon stream from the condenser 222 prior to the entry of the scrubber 234 for removal of contaminant gases prior to entering the reactor.

The apparatus further has a unit for rectification of methanol that includes a flash drum 232, rectification column 228, and a vessel 230 from which methanol is supplied to storage or further processing. This rectification column 228 is used to separate methanol (light-key component) from ethanol (heavy-key component) and water (non-key component). As before, it is desirable for a portion of the heavy key component to enter the distillate stream (as dictated by commercial specification for formalin). For methanol rectification, 99% or higher purity is typical, and 99.999% is achievable with multiple columns. Stream 304 enters the column and the distillate, stream 305, and bottoms, stream 8, exit the column in liquid phase. Stream 308 has some amount of ethanol (and perhaps methanol, if ultra-pure methanol was produced) and will be used as the basis of the aqueous makeup of the commercial formalin stream (stream 311 and formalin storage 291). In this manner, some of the ethanol is recovered before the remainder is discarded in the liquid waste stream.

Disposed between the column 228 and the condenser 222 is a flash drum 232 for removal of CO₂ and formaldehyde from the liquid product stream. The purpose of the flash drum 232 is to drop the pressure to an appropriate level before entry into the methanol rectification column 228 and to substantially remove any dissolved gases, typically CO₂ and formaldehyde, from the liquid product stream.

In operation of the partial oxidation system, the raw hydrocarbon-containing gas stream with a methane content for example up to 98% and the reduced hydrocarbon product stream are supplied from an installation for preparation of gas or any other source to the heater 236, in which it is heated to temperature 430-470° C. The heated hydrocarbon-containing gas is then supplied into two stage reactor 202. Compressed air with pressure, for example, of 7-8 MPa and with a ratio 80% to 100% and, preferably, 90% to 95% oxygen is supplied by the compressor 124 also into reactor 100. Oxidation reaction of methane to methanol and/or formaldehyde takes place in reactor 202. Between 2% and 3% O2 of the total volume of the reactants are reacted with the heated hydrocarbon-containing gas stream as previously described. To limit the amount of N2 within the system, for example to less than 30%-40%, or reduce the requisite size of the purge stream to achieve the same, the O₂ stream is preferably substantially pure, thus limiting the amount of N2 entering the system.

An optional second stream of cold (or, in other words, a lower temperature coolant than the gases) coolant in the reactor is supplied into reactor 202 as previously outlined. This stream is regulated by the regulating device (valve) 220, that can be formed as a known gas supply regulating device, regulating valve, or the like. This cold stream can be, for example, composed of a raw hydrocarbon stream, a recycled stream, or a portion or combination of the two. The regulator is configured to adjust the volume or pressure of cold hydrocarbon-containing gas based on system parameters such as, but not limited to, pressure, temperature, or reaction product percentages at a location further down-stream in the system.

The coolant, which is supplied from a coolant source, functions to reduce the temperature of the partially oxidized methane to reduce the continued oxidation or decomposition of formaldehyde. This coolant can be any material that can easily be separated from the reaction product stream. For example, as better described below, the coolant can be an unheated hydrocarbon or methane containing gas stream.

Preferably, the coolant can be any non-oxidizing material easily separated from the reaction products. In this regard, the coolant can be gaseous, an aerosol, or misted liquid of, for example, CO₂, formaldehyde, methanol, water, and/or steam. It is additionally envisioned that the coolant can further be a mixture of recycled reaction products, water, steam, and/or raw hydrocarbon gases.

Depending on the intended mode of operation of the apparatus, in particular the intended production of methanol or methanol and formaldehyde, the reaction mixture is subjected to the reaction in the reactor without the introduction of the cold hydrocarbon-containing gas if it is desired to produce methanol essentially/exclusively. The introduction of the cold hydrocarbon-containing gas is used when methanol and formaldehyde are both desired as products. By introduction of the cold hydrocarbon-containing gas, the temperature of the reaction is reduced, for example by 30-90° Celsius, so as to preserve the content of formaldehyde in the separated mixture by reducing the decomposition of the formaldehyde into CO₂.

The reaction mixture is supplied into the heat exchanger 214 for transfer of heat to the reactor input stream from the reaction mixture exiting the reactor, and, after further cooling, is supplied to partial condenser 222. Separation of the mixture into high and low volatility components (dry gas and raw liquid, respectively) is performed in the partial condenser 222 that may absorb at least some of the formaldehyde into the raw liquid stream as desired. The dry gas is forwarded to a scrubber 134, while the raw liquids from the condenser 222 are supplied to the flash drum 232.

Scrubber 234 functions to remove the CO₂ and formaldehyde from the dry gas stream. In this regard, the scrubber 234 uses both H₂O and methanol at between 7-8 MPa pressure and between about 0° C. and about 50° C. to absorb CO₂ and formaldehyde. Once the CO₂ and formaldehyde are removed, the reduced stream of hydrocarbon gas is recycled through loop 335 by mixing the reduced stream with the raw hydrocarbon-containing gas stream either before or within the reactor, as desired. The raw hydrocarbon and reduced streams, individually or in combination, are then inputted into mixing chamber 18 at after being heated by heat exchanger 216 and heater 236 as previously described.

Rectification column 238 is used to separate carbon dioxide (non-key component) and formaldehyde (light-key component) from methanol (heavy-key component) and water (non-key component). The pregnant methanol steam, stream 314, enters rectification column 238 and is separated into formaldehyde distillate stream 316 and bottoms stream 315. Some amount of methanol in the distillate stream is desirable since methanol is used as a stabilizer for the production of commercial grade formalin (6-15% alcohol stabilizer, 37% formaldehyde, and the balance being water). By allowing a portion of the heavy key component into the distillate stream the separation is more easily achieved; furthermore, process losses typically experienced during absorbent regeneration are subsequently nullified as methanol within the distillate is used for formalin production. Stream 315 is supplemented by stream 331 so as to replace any methanol that was transferred to the distillate stream, stream 316. Combining stream 331 and stream 315 results in stream 317, which then returns to the scrubber 234 as regenerated methanol absorbent. Meanwhile, the formaldehyde distillate, stream 316, combines with the vapors from flash drum 232, stream 307, to form a mixture of formaldehyde, methanol, and carbon dioxide.

The formaldehyde, water, methanol and CO₂ removed by scrubber 234 are passed to formaldehyde rectification column 238. Column 138 removes formaldehyde and CO₂ from the methanol-water stream. Small amounts of methanol are combined with produced methanol and are inputted into the scrubber 234 to remove additional amounts of CO₂ and formaldehyde from the reduced hydrocarbon stream.

Free or non-aqueous formaldehyde is allowed to remain in the gas phase by operation of the isobaric condenser 222. The liquid methanol product stream, or raw liquids, therefore, comprise methanol, ethanol, and water as far as formaldehyde remains in the gaseous stream. In this case, the liquid stream exiting the isobaric condenser 222 can bypass the formaldehyde rectification portion of the process and enter the methanol rectification column after having optionally passed through the flash drum 232.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An apparatus for partial oxidation comprising:
a mixing chamber configured to receive a first gas feed stream and a second gas feed stream, wherein one of the first gas feed stream and the second gas feed stream includes a hydrocarbon-containing gas while the other includes an oxygen-containing gas, the mixing chamber includes:
an outer tube section having a first input port configured to receive the first gas feed stream;
an internal flow diverter mounted internally to the outer tube section, the internal flow diverter having a second input port that receives the second feed gas stream, the internal flow diverter having a flow diverter wall that defines a central flow channel configured for the second gas feed stream to flow therethrough, the flow diverter wall defining a plurality of gas dispersing channels configured to permit the second gas feed stream to flow out of the internal flow diverter and into a mixing zone defined by the outer tube section and the flow diverter wall, wherein the plurality of gas dispersing channels includes subsets of gas dispersing channels oriented with at least two different angles with respect to the flow diverter wall to promote mixing of the first gas feed stream and of second gas feed stream to form a reactive mixture;
a tubular flow reactor in fluid communication with the mixing chamber and configured to receive the reactive mixture, the tubular flow reactor configured to support the partial oxidation of the hydrocarbon-containing gas as it flows axially therethrough; and
a controller configured to regulate flow of the first gas feed stream and the second gas feed stream.

2. The apparatus of claim 1 wherein the first gas feed stream includes the hydrocarbon-containing gas and the second gas feed stream includes the oxygen-containing gas.

3. The apparatus of claim 1 wherein a plurality of reaction zones are defined in the tubular flow reactor, each reaction zone having a quench input configured to allow flow of a quench gas therethrough to cool the tubular flow reactor.

4. The apparatus of claim 3 further comprising a temperature measuring unit associated with each reaction zone that measures temperature for each reaction zone.

5. The apparatus of claim 4, wherein the controller is configured to provide a quench gas to one or more quench inputs if a temperature of any reaction zone has a value greater than a predetermined temperature.

6. The apparatus of claim 1 wherein the plurality of gas dispersing channels are arranged in a pattern that spirals around the mixing chamber.

7. The apparatus of claim 1 wherein the plurality of gas dispersing channels are arranged such that adjacent channels are oriented at different directions.

8. The apparatus of claim 1 further comprising a first heater for heating the first gas feed stream and a second heater for heating the second gas feed stream.

9. The apparatus of claim 8, wherein the first heater and the second heater are configured to heat first gas feed stream and the second gas feed stream to a sufficient temperature to form alkyl free radicals in the mixing chamber, at least a portion of the alkyl free radicals flowing into the tubular flow reactor.

10. The apparatus of claim 1 further comprising an igniter mounted at least partially in the tubular flow reactor, the igniter configured to generate alkyl free radicals in a sufficient concentration to initial partial oxidation of the hydrocarbon-containing gas as it flows therein.

11. The apparatus of claim 10, wherein the controller is configured to operate the igniter.

12. The apparatus of claim 10, wherein the igniter is a hot surface igniter.

13. The apparatus of claim 10, wherein the igniter is a spark igniter.

14. The apparatus of claim 13, further comprising an ignition control module for controlling the spark igniter.

15. The apparatus of claim 14, wherein the controller is configured to send control signals to the ignition control module to set timing of sparks from the spark igniter.

16. The apparatus of claim 1 further comprising a plurality of fins mounted on an internal surface of the mixing chamber, each fin angled to promote gas mixing.
